(19) United States
(12) Patent Application Publication
(10) Pub. No.: US 2025/0355567 A1
(43) Pub. Date: Nov. 20, 2025

(54) CONTROLLER READ AHEAD USING HOST MEMORY BUFFER

(71) Applicant: Micron Technology, Inc., Boise, ID (US)

(72) Inventors: Marco Redaelli, München (DE); William Thanos, Meridian, ID (US); Kyle J. Wilkins, Meridian, ID (US)

(21) Appl. No.: 19/201,298

(22) Filed: May 7, 2025

Related U.S. Application Data
(60) Provisional application No. 63/648,437, filed on May 16, 2024.

(51) Int. Cl. G06F 3/06

(52) U.S. Cl. CPC G06F 3/0613; G06F 3/0656; G06F 3/0679

(57) ABSTRACT

This disclosure pertains to a method for managing a memory sub-system that improves the efficiency of sequential data retrieval and storage. The methods utilize a host caching buffer (HCB), which is managed by the memory in a circular manner to ensure continuous data availability. The HCB dynamically adjusts to a multiples of the Maximum Data Transfer Size (MDTS) to maintain alignment with slot boundaries, facilitating orderly data management. The system's RAM used for the SSD read-ahead cache is released by the host after data transfer completion, optimizing resource utilization. The methods also include a pointer swap operation for subsequent read requests with prefetched data in the HCB, enhancing data access speed. These advancements provide a robust solution for managing memory sub-systems in computing environments, particularly beneficial for systems requiring efficient sequential data processing.

### PRIORITY APPLICATION

This application claims the benefit of priority to U.S. Provisional Application Ser. No. 63/648,437, filed May 16, 2024, which is incorporated herein by reference in its entirety.

### TECHNICAL FIELD

Examples of the disclosure relate generally to memory sub-systems and, more specifically, to providing media management for memory components, such as memory dies or memory blocks.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data on the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating an example computing environment including a memory sub-system, in accordance with some examples.

FIGS. 2-4 are block diagrams of a process flow for predictive transfer of data to a host caching buffer (HCB), in accordance with some examples.

FIG. 5 is a flow diagram of an example method to perform media management operations, in accordance with some examples.

FIG. 6 is a block diagram illustrating a diagrammatic representation of a machine in the form of a computer system within which a set of instructions can be executed for causing the machine to perform any one or more of the methodologies discussed herein, in accordance with some examples.

### DETAILED DESCRIPTION

The present disclosure configures a system component, such as a memory sub-system controller, to perform predictive read ahead for sequential data and store such data in a dedicated portion (e.g., the HCB) of the memory (e.g., dynamic random access memory (DRA M)) of the host. Specifically, the host can set up the HCB to enable the memory sub-system controller to write data and to enable the host to read data that has been written by the controller. The memory sub-system controller can receive a request to read data and can determine that the request is associated with sequential data. In response, the memory sub-system controller can store a first portion of the data to a first slot of the HCB and can predictively and automatically read and retrieve a second portion of the data. The memory sub-system controller can store the second portion of the data in a second slot of the HCB. When a request is eventually received from the host to read the second portion of the data, the memory sub-system controller provides the storage location of the second slot in response rather than physically accessing the set of memory components of the memory sub-system. This enables the memory sub-system controller to satisfy read requests faster and more efficiently which reduces the overall amount of resources needed to service read requests.

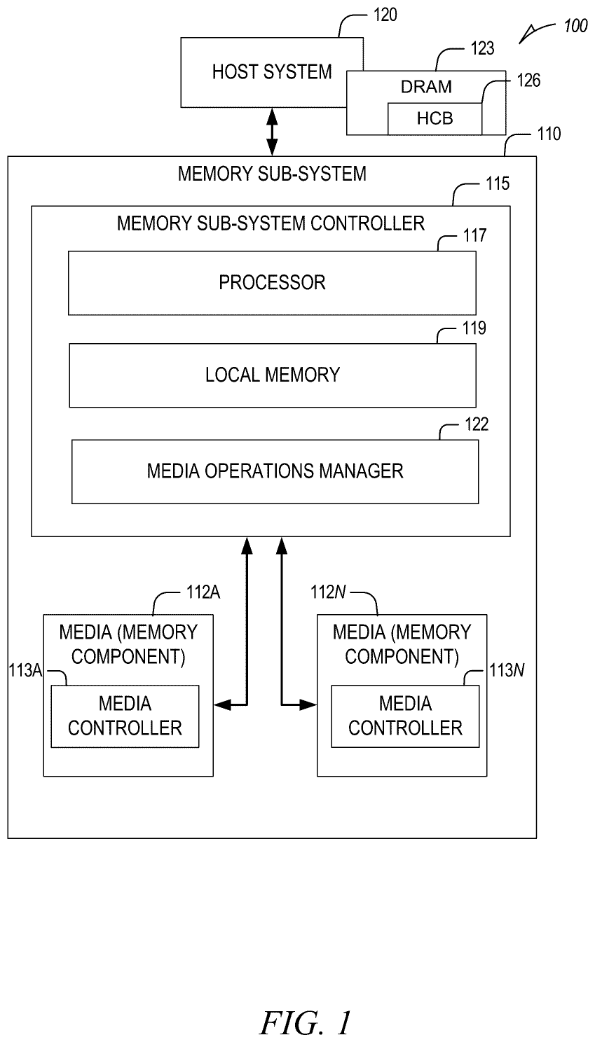

A memory sub-system can be a storage device, a memory module (memory component), or a hybrid of a storage device and memory module. Examples of storage devices and memory modules are described below in conjunction with FIG. 1 In general, a host system can utilize a memory sub-system that includes one or more memory components, such as memory devices (e.g., memory dies) that store data. The host system can send access requests (e.g., write command, read command) to the memory sub-system, such as to store data at the memory sub-system and to read data from the memory sub-system. The data (or set of data) specified by the host is hereinafter referred to as “host data,” “application data,” or “user data”.

The memory sub-system can initiate media management operations, such as a write operation, on host data that is stored on a memory device. For example, firmware of the memory sub-system may re-write previously written host data from a location on a memory device to a new location as part of garbage collection management operations. The data that is re-written, for example as initiated by the firmware, is hereinafter referred to as “garbage collection data” and can be performed periodically for each block stripe (BS) that is stored in the memory sub-system. “U ser data” can include host data and garbage collection data. “System data” hereinafter refers to data that is created and/or maintained by the memory sub-system for performing operations in response to host requests and for media management. Examples of system data include, and are not limited to, system tables (e.g., logical-to-physical address mapping table), data from logging, scratch pad data, etc.

Many different media management operations can be performed on the memory device. For example, the media management operations can include different scan rates, different scan frequencies, different wear leveling, different read disturb management (e.g., read disturb scan operations), different near miss error correction code (ECC), and/or different dynamic data refresh. Wear leveling ensures that all blocks in a memory component approach their defined erase-cycle budget at the same time, rather than some blocks approaching it earlier. Read disturb management counts all of the read operations to the memory component. If a certain threshold is reached, the surrounding regions are refreshed. Near-miss ECC refreshes all data read by the application that exceeds a configured threshold of errors. Dynamic data-refresh scan reads all data and identifies the error status of all blocks as a background operation. If a certain threshold of errors per block or ECC unit is exceeded in this scan-read, a refresh operation is triggered.

A memory device can be a non-volatile memory device. A non-volatile memory device is a package of one or more dice (or dies). Each die can be comprised of one or more planes. For some types of non-volatile memory devices (e.g., NAND devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which is a raw memory device combined with a local embedded controller for memory management within the same memory device package.

There are challenges in efficiently managing or performing sequential read operations on the memory device. Addressing read requests for sequential data in NAND flash memory involves significant technical challenges, even when the system can predict the sequential nature of the reads. One of the primary issues is the inherent delay in waiting for a host read request. Predictive algorithms can anticipate sequential data access patterns, but they must still wait for these requests to be initiated by the host system. This latency can hinder the overall responsiveness and throughput of the storage system, as the NAND controller cannot proactively fetch data until the read request is formally received.

Furthermore, managing these predictions and caching the anticipated data sequences consumes valuable cache resources within the NAND flash memory system. Caching is crucial for enhancing read performance, but it requires careful management to ensure that it does not preemptively fill up with data that might not be immediately needed. This can lead to scenarios where the cache is occupied by predicted sequential data, potentially displacing other data that might be more urgently required by the system. Consequently, while predictive caching strategies aim to improve efficiency, they need to be finely tuned to balance between predictive accuracy and resource utilization effectively.

The present disclosure addresses the above and other deficiencies by providing a memory controller that can prefetch data (e.g., retrieve data from the NAND memory components without a specific request for such data) and store the prefetched data in a dedicated storage location on the host, such as on DRAM. In this way, prefetched data occupies storage resources of the host and does not consume valuable cache resources (e.g., SRAM storage) of the memory sub-system. In some cases, when a request for the data that has been prefetched is received, a pointer to the prefetched data that is already in DRAM is provided in response without having to physically access the NAND memory components. This expedites the rate at which read requests for sequential data are serviced which improves the overall functioning of the memory sub-system.

For example, the controller receives, from a host, a request to read data from a first portion of the set of memory components. The controller determines that the request is associated with sequential data. The controller, in response to determining that the request is associated with sequential data, stores a first portion of data read from the first portion to a first slot of a host caching buffer (HCB) and automatically transfers a second portion of data stored in a second portion of the set of memory components to a second slot of the HCB. In some cases, the second portion of the data sequentially follows the first portion of the data. In some cases, the HCB includes a portion of memory of the host that is external to the memory sub-system. The portion of the memory can be configured to provide only write access to the processing device and is configured to provide only read access to the host.

In some aspects, the host reads the second portion of the data sequentially after reading the first portion of the data. The HCB can include a portion of memory of the host that is external to the memory sub-system. The portion of the memory can be configured to provide only write access to the processing device and is configured to provide only read access to the host.

In some examples, the controller detects that a sequential data flag is included in the request, wherein the request is determined to be associated with sequential data in response to detecting the sequential data flag. In some cases, the controller applies a predictive model to the request to predict that the request is associated with sequential data. The controller can receive configuration information from the host that selects a condition or preferences for determining that data corresponds to sequential data, the condition or preferences being associated with one or more of a sequential data flag and a predictive model application.

In some cases, the controller identifies the second portion of the set of memory components in which the second portion of the data is stored. The controller, after storing the first portion to the first slot, automatically retrieving the second portion of the data from the second portion of the set of memory components without receiving a request for the second portion from the host to continue filling read data in subsequent slots of the HCB beyond the second slot.

The controller can store the second portion of the data to the first slot of the HCB. In some cases, the controller receives an additional request from the host to read the second portion of the data and determines that the second portion of the data has been transferred to the second slot. The controller, in response to determining that the second portion of the data has been transferred to the second slot, provides to the host a pointer to the second slot in which the second portion of data has been stored without accessing the set of memory components.

In some cases, the data is stored in a list of slots in the HCB in a circular manner. A size of the HCB can be configurable by a user of the host. In some cases, a size of slots of the HCB corresponds to a maximum transfer size (MDTS) of the memory sub-system. Transfer of data to the HCB can be executed in sizes that are sub-multiples of the MDTS and wherein such transfers maintain alignment with slot boundaries of the HCB which are determined by the MDTS.

The controller can determine that the request includes a pointer to a first target storage location in which to place the first portion of the data. In such cases, the controller, in response to determining that the request is associated with sequential data, identifies a second target storage location of the first slot of the HCB and performs a point swap operation including swapping the first target storage location with the second target storage location to communicate the second target storage location to the host. The second portion of the data can be predicted by the controller to be accessed within a specified period of time and the pointer swap operation can be executed for any subsequent read request by the host for which data has already been prefetched into the HCB.

The controller can store a table that identifies memory portions from which data has been prefetched automatically and stored in the HCB. In some cases, the controller can determine that the host has accessed one or more slots of the HCB and stores new data to the one or more slots of the HCB that have been accessed by the host. The controller, upon completion of transfer of data stored in one or more slots of the HCB to the host, releases utilized slots in the HCB to enable the processing device to continue filling the HCB with predictively cached sequential data.

The memory sub-system can be further configured to manage the HCB in a circular manner allowing for continuous and sequential filling and invalidation of data slots within the HCB, thereby enabling the host to maintain a consistent flow of data read-ahead beyond the initial slots, in accordance with one or more sequential data requests from the host.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing environment 100 including a memory sub-system 110, in accordance with some examples. The memory sub-system 110 can include media, such as memory components 112A to 112N (also hereinafter referred to as “memory devices”). The memory components 112A to 112N can be volatile memory devices, non-volatile memory devices, or a combination of such. The memory components 112A to 112N can be implemented by individual dies, such that a first memory component 112A can be implemented by a first memory die (or a first collection of memory dies) and a second memory component 112N can be implemented by a second memory die (or a second collection of memory dies).

In some examples, the memory sub-system 110 is a storage system. A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIM M), a small outline DIMM (SO-DIMM), and a non-volatile dual in-line memory module (NVDIMM).

The computing environment 100 can include a host system 120 that is coupled to a memory system. The memory system can include one or more memory sub-systems 110. In some examples, the host system 120 is coupled to different types of memory sub-systems 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL), a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NV Me) interface to access the memory components 112A to 112N when the memory sub-system 110 is coupled with the host system 120 by the PCIe or CXL interface. The physical host interface can provide an interface for passing control, address, data, and other signals between the memory sub-system 110 and the host system 120.

The host system 120 can include a local memory, such as a DRAM 122. The host system 120 can configure a portion of the DRAM 122 to include a host memory buffer (HM B) and/or an HCB 126. In some cases, a portion of the HM B can be used to implement the HCB 126. HMB is a technology used in the context of NAND flash storage, particularly in solid-state drives (SSDs), to enhance performance without significantly increasing the cost. HM B leverages a portion of the host system's DRAM 122 instead of using the SSD to have its own extensive onboard DRAM cache. This approach allows SSDs to utilize the high-speed DRA M of the host computer to store mapping tables and other frequently accessed data that are critical for the SSD's operation.

The primary advantage of using HM B technology is that it enables lower-cost SSDs to achieve higher performance levels that are closer to those of higher-end SSDs with built-in DRAM 122. By offloading some of the data storage and caching tasks to the host's DRAM 122, SSDs can reduce latency and improve overall data throughput for read and write operations. This setup is particularly beneficial in consumer-grade products and systems where cost constraints are significant, but performance improvements are still sought. HM B also simplifies the SSD design, potentially reducing power consumption and physical space requirements within the drive.

When an SSD with HM B support is connected, it communicates its need for DRAM to the host system 120, which then allocates a specific portion of its DRAM 122 for SSD use. This allocation is managed by the host's operating system to ensure it does not negatively impact overall system performance. The primary use of this allocated DRAM 122 is to store the SSD's mapping tables, which track the correspondence between data blocks in the NAND and logical addresses in the system. Having these tables in the host's fast-access DRAM 122 allows the SSD to speed up data retrieval and writing processes significantly. During read/write operations, the SSD controller can quickly access or update these mapping tables, reducing the time it takes to locate data in the NAND flash array, thus enhancing the SSD's performance, especially in random access tasks.

Additionally, to maintain data integrity, the SSD periodically synchronizes the mapping table data in the host's DRAM 122 with its internal non-volatile memory. This can be important for protecting data against potential losses due to power failures or system crashes. The SSD controller (e.g., memory sub-system controller 115) also optimizes data caching and access based on usage patterns, improving performance and extending the NAND flash's lifespan by minimizing unnecessary write operations. By offloading memory-intensive tasks to the host's DRAM 122, HMB enables SSDs to achieve higher performance levels without the cost and power consumption associated with large amounts of onboard DRAM, making it particularly beneficial for budget-conscious SSDs.

The HCB 126 portion of the HM B can be configured to allow the memory sub-system 110 to only write or store data in the HCB 126 and to allow the host system 120 to only read data from the HCB. In some examples, the size of the HCB 126 can be specified or set by the host system 120 (e.g., by a user of the host system 120) or can be dynamically changed based on the needs of the host system 120 and/or the memory sub-system 110. The HCB 126 can be made up of multiple slots. Each slot can be configured to store an amount of data corresponding to a maximum transfer size (MTS) of the memory sub-system 110 and/or a fraction or multiple of the MTS. In some cases, transfer of data to the HCB can be executed in sizes that are sub-multiples of the MDTS. Such transfers maintain alignment with slot boundaries of the HCB which are determined by the MDTS.

In some examples, the memory sub-system controller 115 can predictively retrieve sequential data from portions of the set of memory components 112A to 112N. The predictively retrieved data can be stored in the HCB 126 by the memory sub-system controller 115. For example, the memory sub-system controller 115 can receive a request from the host system 120 to read a set of data to the set of memory components 112A to 112N. The memory sub-system controller 115 can determine that the set of data is part of a sequential set of data (which may be stored in sequentially adjacent portions of the set of memory components 112A to 112N or in non-adjacent portion). In some cases, the memory sub-system controller 115 can determine that the set of data is part of a sequential set of data in response to detecting a sequential flag or bit in the request received from the host system 120. In some cases, the memory sub-system controller 115 can determine that the set of data is part of a sequential set of data by applying a predictive model to the set of data that detects patterns of access and predicting that the set of data is part of the sequential set of data.

In some cases, the host system 120 can configure one or more conditions or criteria or preferences for the memory sub-system controller 115 to use to determining that data is part of sequential set of data. Specifically, the host system 120 can provide configuration information to the memory sub-system controller 115 that lists conditions, criteria and/or preferences. The memory sub-system controller 115 can then apply the conditions, criteria and/or preferences to data retrieval requests to determine whether such requests correspond to sequential data. The conditions, criteria and/or preferences can specify whether a sequential data flag and/or a predictive model is used to control the determination of data being part of a sequential data set.

In response to determining that the set of data is part of the sequential set of data, the memory sub-system controller 115 can service the request to read the set of data by storing the retrieved set of data to a first slot in the HCB 126. The memory sub-system controller 115 can return a pointer to the host system 120 that identifies the first slot. Specifically, the memory sub-system controller 115 can perform a point swap operation in which the target memory address received in the request is swapped with the address of the first slot. Namely, the memory sub-system controller 115 can store the retrieved data in the first slot instead of a target memory address received in the request to read data from the host system 120. After providing the pointer to the host system 120 that identifies the first slot of the HCB 126, the memory sub-system controller 115 can automatically (without receiving or prior to receiving an additional request to read an additional set of data) retrieve or prefetch a second set of data from the set of memory components 112A to 112N. The second set of data can be retrieved from a memory location that has been determined to store a next set data in the sequential set of data. Specifically, the pointer swap operation can be executed for any subsequent read request by the host system 120 for which data has already been prefetched into the HCB.

The memory sub-system controller 115 can automatically store or transfer the second set of data that has been prefetched in a second slot of the HCB 126. The memory sub-system controller 115 can subsequently receive a request from the host system 120 to read the second set of data. The memory sub-system controller 115 can access a table that identifies prefetched data to identify which data portions have previously been cached in the HCB 126. The memory sub-system controller 115 can determine that the request received from the host system 120 matches an address stored in the table. In response, the memory sub-system controller 115 can retrieve from the table an identifier of the slot of the HCB 126 in which the data corresponding to the address in the request has been cached. The memory sub-system controller 115 can then service the request to read the second set of data by returning to the host system 120 a pointer to the second slot without accessing or retrieving the data from the set of memory components 112A to 112N.

The memory sub-system controller 115 can receive a message or indication from the host system 120 that one or more slots of the HCB 126 have been accessed. This can be performed by accessing a completion queue associated with the host system 120. In response, the memory sub-system controller 115 can invalidate the one or more slots and reuse those slots to cache new prefetched data. The memory sub-system controller 115 can continue filling or caching data in the slots of the HCB 126 in a round robin or circular manner. For example, after reaching the last slot in the HCB 126, the memory sub-system controller 115 can cache new data in the first slot of the HCB 126. In some cases, if the first slot of the HCB 126 still stores valid data (e.g., data that has not been accessed by the host system 120), the memory sub-system controller 115 can stop prefetching and caching new data until the first slot is read by the host system 120 and/or until a threshold period of time elapses since the data has been stored in the first slot.

The memory components 112A to 112N can include any combination of the different types of non-volatile memory components and/or volatile memory components. An example of non-volatile memory components includes NOR- and (NAND)-type flash memory. Each of the memory components 112A to 112N can include one or more arrays of memory cells such as single-level cells (SL Cs) or multi-level cells (MLCs) (e.g., TLCs or QLCs). In some examples, a particular memory component 112 can include both an SLC portion and an MLC portion of memory cells. Each of the memory cells can store one or more bits of data (e.g., blocks) used by the host system 120. Although non-volatile memory components such as NAND-type flash memory are described, the memory components 112A to 112N can be based on any other type of memory, such as a volatile memory.

In some examples, the memory components 112A to 112N can be, but are not limited to, random access memory (RAM), read-only memory (ROM), dynamic random access memory (DRAM), synchronous dynamic random access memory (SDRAM), phase change memory (PCM), magnetoresistive random access memory (MRAM), (NOR) flash memory, electrically erasable programmable read-only memory (EEPROM), and a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, the memory cells of the memory components 112A to 112N can be grouped as memory pages, WLs, planes, blocks, or sub-blocks that can refer to a unit of the memory component 112 used to store data. In general, the memory pages, WLs, sub-blocks, and/or blocks are collectively or individually referred to as memory components.

The memory sub-system controller 115 can communicate with the memory components 112A to 112N to perform operations such as reading data, writing data, or erasing data at the memory components 112A to 112N and other such operations. The memory sub-system controller 115 can communicate with the memory components 112A to 112N to perform various memory management operations, such as different scan rates, different scan frequencies, different wear leveling, different read disturb management operations, such as read disturb scan operations, different near miss ECC operations, folding operations, preventing folding operations from being performed, and/or different dynamic data refresh operations.

The memory sub-system controller 115 can include hardware such as one or more integrated circuits and/or discrete components, one or more thermometers (used to measure a current operating temperature of the memory sub-system 110 and/or the memory components 112A to 112N or ambient temperature), a buffer memory, and/or a combination thereof. In some examples, the output of the one or more thermometers can be used to determine a current write temperature to be stored in association with data on the memory components 112A to 112N.

The memory sub-system controller 115 can be a microcontroller, special-purpose logic circuitry (e.g., a field programmable gate array (FPGA), an application specific integrated circuit (ASIC), etc.), or another suitable processor. The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some examples, the local memory 119 can include memory registers storing memory pointers, fetched data, and so forth. The local memory 119 can also include read-only memory (ROM) for storing microcode. While the example memory sub-system 110 in FIG. 1 has been illustrated as including the memory sub-system controller 115, in another example, a memory sub-system 110 may not include a memory sub-system controller 115, and can instead rely upon external control (e.g., provided by an external host, or by a processor 117 or controller separate from the memory sub-system 110).

In general, the memory sub-system controller 115 can receive commands or operations from the host system 120 and can convert the commands or operations into instructions or appropriate commands to achieve the desired access to the memory components 112A to 112N. In some examples, the commands or operations received from the host system 120 can specify configuration data for the memory components 112N to 112N.

The memory sub-system controller 115 can be responsible for other memory management operations, such as wear leveling operations, garbage collection operations, error detection and error-correcting code (ECC) operations, encryption operations, caching operations, media scans (where different block stripes are read and analyzed for errors to determine whether to refresh or fold the block stripe), data refreshing, read disturb operations, and address translations. The memory sub-system controller 115 can further include host interface circuitry to communicate with the host system 120 via the physical host interface. The host interface circuitry can convert the commands received from the host system 120 into command instructions to access the memory components 112A to 112N as well as convert responses associated with the memory components 112A to 112N into information for the host system 120.

The memory sub-system 110 can also include additional circuitry or components that are not illustrated. In some examples, the memory sub-system 110 can include a cache or buffer (e.g., DRAM or other temporary storage location or device) and address circuitry (e.g., a row decoder and a column decoder) that can receive an address from the memory sub-system controller 115 and decode the address to access the memory components 112A to 112N.

The memory devices can be raw memory devices (e.g., NAND), which are managed externally, for example, by an external controller (e.g., memory sub-system controller 115). The memory devices can be a managed memory devices (e.g., managed NAND), which is a raw memory device combined with a local embedded controller (e.g., local media controllers) for memory management within the same memory device package. Any one of the memory components 112A to 112N can include a media controller (e.g., media controller 113A and media controller 113N) to manage the memory cells of the memory component (e.g., to perform one or more memory management operations), to communicate with the memory sub-system controller 115, and to execute memory requests (e.g., read or write) received from the memory sub-system controller 115.

The memory sub-system controller 115 can include a media operations manager 122. The media operations manager 122 can be configured to receive, from the host system 120, a request to read data from a first portion of a set of memory components 112A to 112N and determines that the request is associated with sequential data. The media operations manager 122, in response to determining that the request is associated with sequential data, stores a first portion of data read from the first portion to a first slot of the HCB 126 and automatically transfers a second portion of data stored in a second portion of the set of memory components 112A to 112N to a second slot of the HCB 126.

Depending on the examples, the media operations manager 122 can comprise logic (e.g., a set of transitory or non-transitory machine instructions, such as firmware) or one or more components that causes the media operations manager 122 to perform operations described herein. The media operations manager 122 can comprise a tangible or non-tangible unit capable of performing operations described herein. Further details with regards to the operations of the media operations manager 122 are described below.

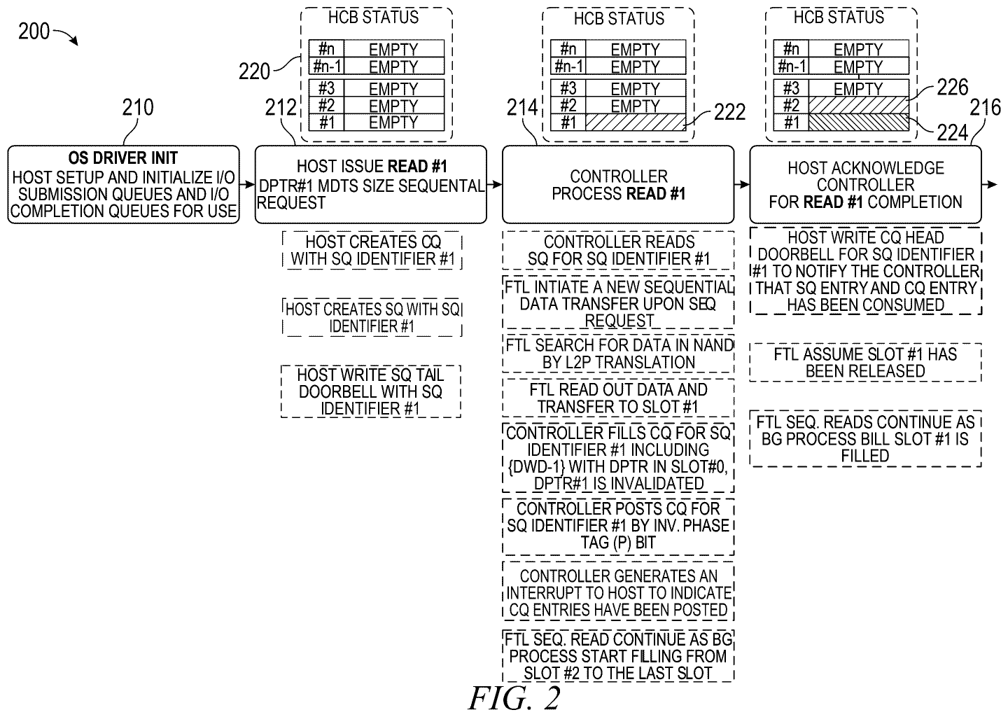

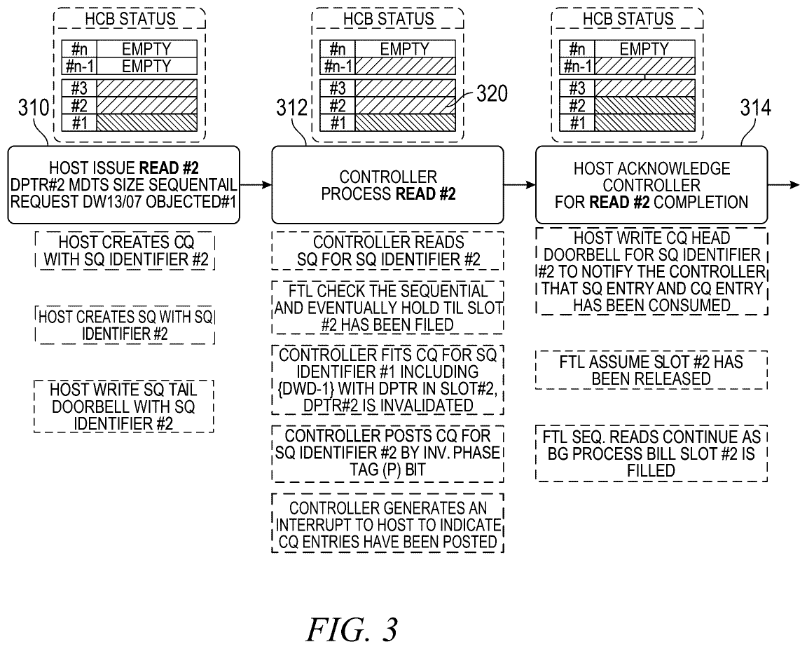

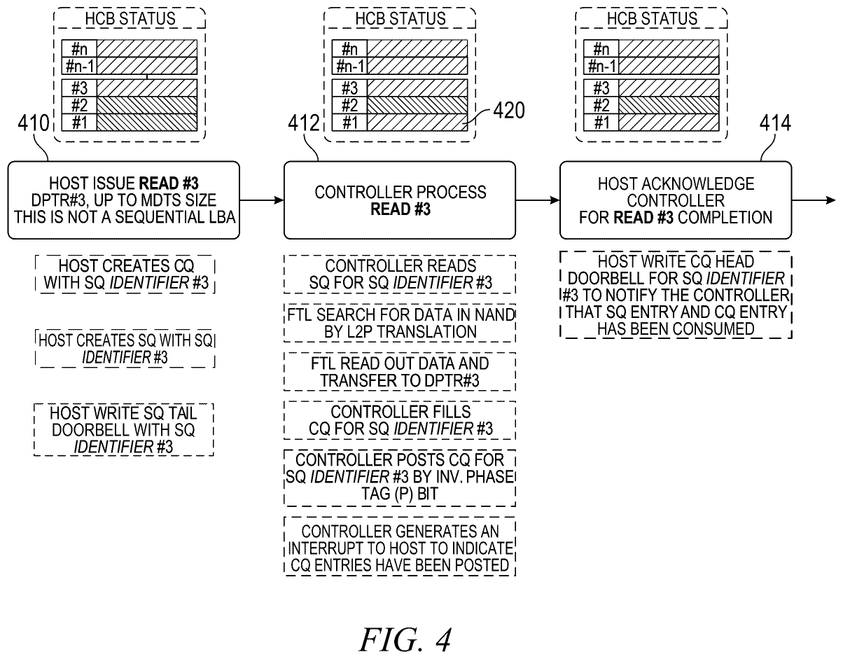

FIGS. 2-4 are block diagrams of a process flow 200 for predictive transfer of data to the HCB 126, in accordance with some examples. For example, at operation 210, the host system 120 can include a driver unit that sets up and initializes I/O submission queues (SQs) and completion queues (CQs). These queues can be used to exchange messages between the host system 120 and the memory sub-system controller 115 indicating which data needs to be read/written from the set of memory components 112A to 112N and the status of servicing such requests. For example, the host system 120 can issue a first read request 212. The first read request 212 can identify a first portion of data to be read from the memory sub-system 110 and a target storage location in the DRAM 122 to store the data. The target storage location can be a location in the DRAM 122 that does not include the HCB 126. The first read request 212 can also specify that the first portion of data is part of a sequential set of data.

The host system 120 can create a CQ that corresponds to a SQ identifier and creates a corresponding SQ having the SQ identifier. The host system 120 can write a SQ message (e.g., tail doorbell) to inform the memory sub-system controller 115 that a read request needs to be serviced. The host system 120 can maintain the HCB 126 that includes multiple slots indifferent states, as shown in the example HCB status table 220. The memory sub-system controller 115 can receive the first read request 212 at operation 214. The memory sub-system controller 115 can read the SQ for the SQ identifier and can initiate sequential data transfer operation in response to detecting a sequential data flag in the first read request 212. The memory sub-system controller 115 retrieves the requested data from the set of memory components 112A to 112N based on a logical to physical address translation of the address included in the first read request 212.

The memory sub-system controller 115 stores the retrieved data in a first slot 222 (e.g., Slot #1) of the HCB 126. The memory sub-system controller 115 can invalidate the target storage location (e.g., DPTR #1) and fills the CQ for the SQ identifier with an address of the first slot 222 (e.g., the DPTR in Slot #1). The memory sub-system controller 115 can generate an interrupt to the host system 120 to indicate that the CQ entries have been posted and to cause the host system 120 to access the data that has been stored in the first slot 222. While the host system 120 accesses the first slot 222, the memory sub-system controller 115 can read other sequential data portions and transfer those portions to adjacent slots, such as Slot #2 (e.g., a second slot 226), Slot #3, and so forth.

The host system 120 can acknowledge to the memory sub-system controller 115 at operation 216 that the first read request 212 has been completed. At this point, the memory sub-system controller 115 converts the first slot 222 to an invalidated slot 224. The host system 120 can write the CQ head a doorbell message for the SQ identifier to notify the memory sub-system controller 115 that the SQ entry and the CQ entry have been consumed. The memory sub-system controller 115 can assume that the first slot 222 has been read and released and the memory sub-system controller 115 continues precaching sequential reads and filling read data in the second slot 226 and adjacent slots.

At some later time, the host system 120 can generate a second read request 310. The second read request 310 can identify a second portion of data to be read from the memory sub-system 110 and a target storage location in the DRAM 122 to store the data. The target storage location can be a location in the DRAM 122 that does not include the HCB 126. The second read request 310 can also specify that the second portion of data is part of the sequential set of data.

The host system 120 can create a CQ that corresponds to an additional SQ identifier and creates a corresponding SQ having the additional SQ identifier. The host system 120 can write a SQ message (e.g., tail doorbell) to inform the memory sub-system controller 115 that a read request needs to be serviced. The memory sub-system controller 115 can receive the second read request 310 at operation 312. The memory sub-system controller 115 can read the SQ for the additional SQ identifier and can check a table to determine whether at least a portion of the second portion of data has been prefetched and cached in the second slot 320. The memory sub-system controller 115 can complete filling the second slot 320 with the second portion of the data if the second portion of the data has not been completely prefetched and cached.

The memory sub-system controller 115 can invalidate the target storage location (e.g., DPTR #1) and fills the CQ for the additional SQ identifier with an address of the second slot 320. The memory sub-system controller 115 can generate an interrupt to the host system 120 to indicate that the CQ entries have been posted and to cause the host system 120 to access the data that has been stored in the second slot 320. In this way, the second slot 320 can be filled with data prior to receiving a request from the host system 120 for the data. At operation 314, the host system 120 can acknowledge to the memory sub-system controller 115 that the second read request 310 has been completed. At this point, the memory sub-system controller 115 converts the second slot 320 to an invalidated slot to enable writing to the second slot 320. The host system 120 can write the CQ head a doorbell message for the SQ identifier to notify the memory sub-system controller 115 that the SQ entry and the CQ entry have been consumed. The memory sub-system controller 115 can assume that the second slot 320 has been read and released and the memory sub-system controller 115 continues precaching sequential reads and filling read data in the third slot and adjacent slots.

In some examples, after performing operation 314, the host system 120 can issue a third read request 410. The third read request 410 may not be associated with the sequential data set. The memory sub-system controller 115 can receive and process the third read request 410 at operation 412. The memory sub-system controller 115 can search the table to determine that the address associated with the third read request 410 has not been cached or prefetched. In such cases, in response to determining that the address associated with the third read request 410 is not sequential and has not been cached in the HCB 126, the memory sub-system controller 115 retrieves the data from the set of memory components 112A to 112N and returns the data to the host system 120 at the target storage location specified by the host system 120 in the third read request 410. The first slot 420 may be completely read at this point and be ready for being programmed with additional data after all other slots in the HCB 126 have been programmed with sequential data. At operation 414, the host system 120 acknowledges completion of the third read request 410.

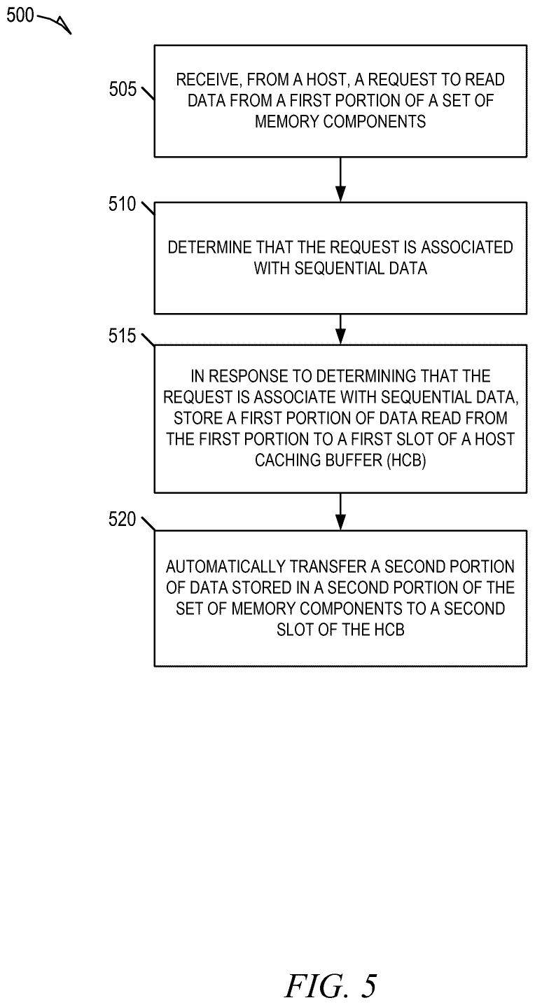

FIG. 5 is a flow diagram of an example method 500 to perform media management operations, in accordance with some examples. The method 500 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some examples, the method 500 is performed by the media operations manager 122 of FIG. 1 Although the processes are shown in a particular sequence or order, unless otherwise specified, the order of the processes can be modified. Thus, the illustrated examples should be understood only as examples, and the illustrated processes can be performed in a different order, and some processes can be performed in parallel. Additionally, one or more processes can be omitted in various examples. Thus, not all processes are required in every example. Other process flows are possible.

Referring now to FIG. 5, the method (or process) 500 begins at operation 505 where the media operations manager 122 (e.g., the firmware of the memory sub-system 110) receives, from host system 120, a request to read data from a first portion of a set of memory components 112A to 112N. The media operations manager 122, at operation 510, determines that the request is associated with sequential data and, at operation 515, in response to determining that the request is associated with sequential data, stores a first portion of data read from the first portion to a first slot of the HCB 126. At operation 520, the media operations manager 122 automatically transfers a second portion of data stored in a second portion of the set of memory components 112A to 112N to a second slot of the HCB 126.

In view of the disclosure above, various examples are set forth below. It should be noted that one or more features of an example, taken in isolation or combination, should be considered within the disclosure of this application.

Example 1. A system comprising: a set of memory components of a memory sub-system; and a processing device operatively coupled to the set of memory components, the processing device being configured to perform operations comprising: receiving, from a host, a request to read data from a first portion of the set of memory components; determining that the request is associated with sequential data; in response to determining that the request is associated with sequential data, storing a first portion of data read from the first portion to a first slot of a host caching buffer (HCB); and automatically transferring a second portion of data stored in a second portion of the set of memory components to a second slot of the HCB.

Example 2. The system of Example 1, wherein the host reads the second portion of the data sequentially after reading the first portion of the data.

Example 3. The system of any one of Examples 1-2, wherein the HCB comprises a portion of memory of the host that is external to the memory sub-system.

Example 4. The system of Example 3, wherein the portion of the memory is configured to provide only write access to the processing device and is configured to provide only read access to the host.

Example 5. The system of any one of Examples 1-4, the operations comprising: detecting that a sequential data flag is included in the request, wherein the request is determined to be associated with sequential data in response to detecting the sequential data flag.

Example 6. The system of any one of Examples 1-5, the operations comprising: applying a predictive model to the request to predict that the request is associated with sequential data.

Example 7. The system of any one of Examples 1-6, the operations comprising: receiving configuration information from the host that selects a condition or preferences for determining that data corresponds to sequential data, the condition or preferences being associated with one or more of a sequential data flag and a predictive model application.

Example 8. The system of any one of Examples 1-7, the operations comprising: identifying the second portion of the set of memory components in which the second portion of the data is stored; and after storing the first portion to the first slot, automatically retrieving the second portion of the data from the second portion of the set of memory components without receiving a request for the second portion from the host to continue filling read data in subsequent slots of the HCB beyond the second slot.

Example 9. The system of Example 8, the operations comprising: storing the second portion of the data to the first slot of the HCB.

Example 10. The system of any one of Examples 8-9, the operations comprising: receiving an additional request from the host to read the second portion of the data; determining that the second portion of the data has been transferred to the second slot; and in response to determining that the second portion of the data has been transferred to the second slot, providing to the host a pointer to the second slot in which the second portion of data has been stored without accessing the set of memory components.

Example 11. The system of any one of Examples 1-10, wherein data is stored in a list of slots in the HCB in a circular manner.

Example 12. The system of any one of Examples 11, wherein a size of the HCB is configurable by a user of the host.

Example 13. The system of any one of Examples 1-12, wherein a size of slots of the HCB corresponds to a maximum transfer size (MDTS) of the memory sub-system, wherein transfer of data to the host caching buffer (HCB) is executed in sizes that are sub-multiples of the MDTS, and wherein such transfers maintain alignment with slot boundaries of the HCB which are determined by the MDTS.

Example 14. The system of any one of Examples 1-13, the operations comprising: determining that the request comprises a pointer to a first target storage location in which to place the first portion of the data; in response to determining that the request is associated with sequential data, identifying a second target storage location of the first slot of the HCB; and performing a point swap operation comprising swapping the first target storage location with the second target storage location to communicate the second target storage location to the host.

Example 15. The system of Example 14, wherein the second portion of the data is predicted by the processing device to be accessed within a specified period of time, and wherein the pointer swap operation is executed for any subsequent read request by the host for which data has already been prefetched into the HCB.

Example 16. The system of any one of Examples 1-15, the operations comprising: storing a table that identifies memory portions from which data has been prefetched automatically and stored in the HCB.

Example 17. The system of any one of Examples 1-16, the operations comprising: determining that the host has accessed one or more slots of the HCB; storing new data to the one or more slots of the HCB that have been accessed by the host; and upon completion of transfer of data stored in one or more slots of the HCB to the host, releasing utilized slots in the HCB to enable the processing device to continue filling the HCB with predictively cached sequential data.

Example 18. The system of any one of Examples 1-17, wherein the memory sub-system is further configured to manage the host caching buffer (HCB) in a circular manner, allowing for continuous and sequential filling and invalidation of data slots within the HCB, thereby enabling the host to maintain a consistent flow of data read-ahead beyond the initial slots, in accordance with one or more sequential data requests from the host.

Methods and computer-readable storage medium with instructions for performing any one of the above Examples.

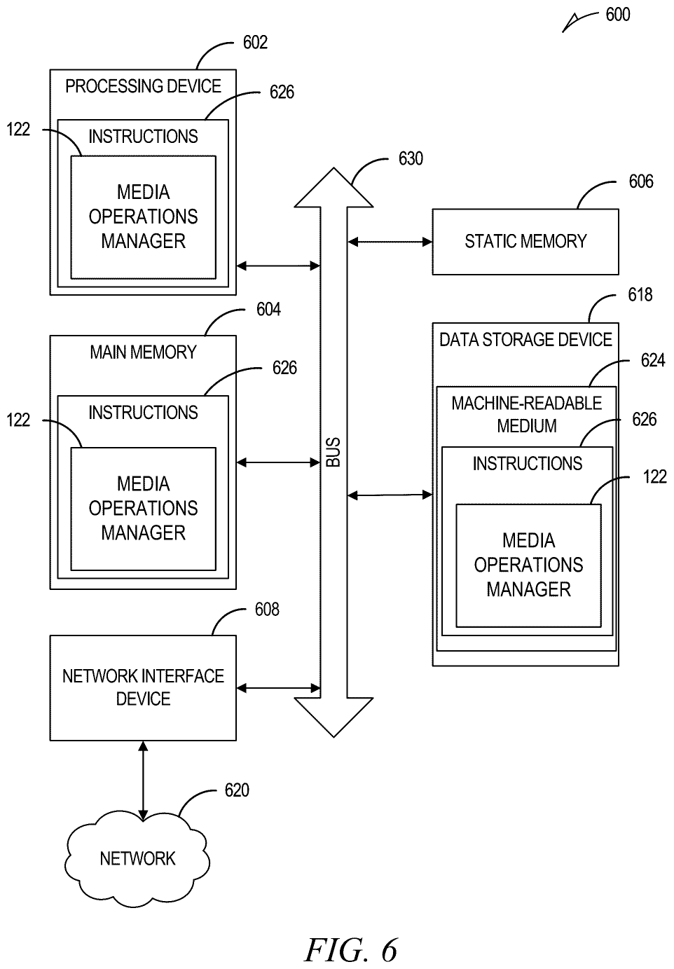

FIG. 6 illustrates an example machine in the form of a computer system 600 within which a set of instructions can be executed for causing the machine to perform any one or more of the methodologies discussed herein. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the media operations manager 122 of FIG. 1). In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a network switch, a network bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

The processing device 602 represents one or more general-purpose processing devices such as a microprocessor, a central processing unit, or the like. More particularly, the processing device 602 can be a complex instruction set computing (CISC) microprocessor, a reduced instruction set computing (RISC) microprocessor, a very long instruction word (V LIW) microprocessor, a processor implementing other instruction sets, or processors implementing a combination of instruction sets. The processing device 602 can also be one or more special-purpose processing devices such as an application specific integrated circuit (ASIC), a field programmable gate array (FPGA), a digital signal processor (DSP), a network processor, or the like. The processing device 602 is configured to execute instructions 626 for performing the operations and steps discussed herein. The computer system 600 can further include a network interface device 608 to communicate over a network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1

In one embodiment, the instructions 626 implement functionality corresponding to the media operations manager 122 of FIG. 1 While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system's memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; read-only memories (ROM s); random access memories (RAMs); erasable programmable read-only memories (EPROMs); EEPROMS; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine-readable (e.g., computer-readable) storage medium such as a read-only memory (ROM), random access memory (RAM), magnetic disk storage media, optical storage media, flash memory components, and so forth.

In the foregoing specification, examples of the disclosure have been described with reference to specific example embodiments thereof. It will be evident that various modifications can be made thereto without departing from the broader examples of the disclosure as set forth in the following claims. The specification and drawings are, accordingly, to be regarded in an illustrative sense rather than a restrictive sense.

What is claimed is:

1. A system comprising:
a set of memory components of a memory sub-system; and
a processing device operatively coupled to the set of memory components, the processing device being configured to perform operations comprising:
receiving, from a host, a request to read data from a first portion of the set of memory components;
determining that the request is associated with sequential data;
in response to determining that the request is associated with sequential data, storing a first portion of data read from the first portion to a first slot of a host caching buffer (HCB); and
automatically transferring a second portion of data stored in a second portion of the set of memory components to a second slot of the HCB.

2. The system of claim 1, wherein the host reads the second portion of the data sequentially after reading the first portion of the data.

3. The system of claim 1, wherein the HCB comprises a portion of memory of the host that is external to the memory sub-system.

4. The system of claim 3, wherein the portion of the memory is configured to provide only write access to the processing device and is configured to provide only read access to the host.

5. The system of claim 1, the operations comprising:
detecting that a sequential data flag is included in the request, wherein the request is determined to be associated with sequential data in response to detecting the sequential data flag.

6. The system of claim 1, the operations comprising:
applying a predictive model to the request to predict that the request is associated with sequential data.

7. The system of claim 1, the operations comprising:
receiving configuration information from the host that selects a condition or preferences for determining that data corresponds to sequential data, the condition or preferences being associated with one or more of a sequential data flag and a predictive model application.

8. The system of claim 1, the operations comprising:
identifying the second portion of the set of memory components in which the second portion of the data is stored; and
after storing the first portion to the first slot, automatically retrieving the second portion of the data from the second portion of the set of memory components without receiving a request for the second portion from the host to continue filling read data in subsequent slots of the HCB beyond the second slot.

9. The system of claim 8, the operations comprising:
storing the second portion of the data to the first slot of the HCB.

10. The system of claim 8, the operations comprising:
receiving an additional request from the host to read the second portion of the data;
determining that the second portion of the data has been transferred to the second slot; and
in response to determining that the second portion of the data has been transferred to the second slot, providing to the host a pointer to the second slot in which the second portion of data has been stored without accessing the set of memory components.

11. The system of claim 1, wherein data is stored in a list of slots in the HCB in a circular manner.

12. The system of claim 1, wherein a size of the HCB is configurable by a user of the host.

13. The system of claim 1, wherein a size of slots of the HCB corresponds to a maximum transfer size (MDTS) of the memory sub-system, wherein transfer of data to the host caching buffer (HCB) is executed in sizes that are sub-multiples of the MDTS, and wherein such transfers maintain alignment with slot boundaries of the HCB which are determined by the MDTS.

14. The system of claim 1, the operations comprising:
determining that the request comprises a pointer to a first target storage location in which to place the first portion of the data;
in response to determining that the request is associated with sequential data, identifying a second target storage location of the first slot of the HCB; and
performing a point swap operation comprising swapping the first target storage location with the second target storage location to communicate the second target storage location to the host.

15. The system of claim 14, wherein the second portion of the data is predicted by the processing device to be accessed within a specified period of time, and wherein the pointer swap operation is executed for any subsequent read request by the host for which data has already been prefetched into the HCB.

16. The system of claim 1, the operations comprising:
storing a table that identifies memory portions from which data has been prefetched automatically and stored in the HCB.

17. The system of claim 1, the operations comprising:
determining that the host has accessed one or more slots of the HCB;
storing new data to the one or more slots of the HCB that have been accessed by the host; and
upon completion of transfer of data stored in one or more slots of the HCB to the host, releasing utilized slots in the HCB to enable the processing device to continue filling the HCB with predictively cached sequential data.

18. The system of claim 1, wherein the memory sub-system is further configured to manage the host caching buffer (HCB) in a circular manner, allowing for continuous and sequential filling and invalidation of data slots within the HCB, thereby enabling the host to maintain a consistent flow of data read-ahead beyond initial slots, in accordance with one or more sequential data requests from the host.

19. A method comprising:
receiving, from a host, a request to read data from a first portion of a set of memory components;
determining that the request is associated with sequential data;
in response to determining that the request is associated with sequential data, storing a first portion of data read from the first portion to a first slot of a host caching buffer (HCB); and
automatically transferring a second portion of data stored in a second portion of the set of memory components to a second slot of the HCB.

20. A non-transitory computer-readable storage medium comprising instructions that, when executed by a processing device, cause the processing device to perform operations comprising:
receiving, from a host, a request to read data from a first portion of a set of memory components;
determining that the request is associated with sequential data;
in response to determining that the request is associated with sequential data, storing a first portion of data read from the first portion to a first slot of a host caching buffer (HCB); and
automatically transferring a second portion of data stored in a second portion of the set of memory components to a second slot of the HCB.
